(19) United States
(12) Patent Application Publication
(10) Pub. No.: US 2026/0303452 A1
(43) Pub. Date: Oct. 1, 2026

(54) CONFIGURATION CONSISTENCY MAINTENANCE DURING DATA CENTER COMPONENT UPGRADES

(71) Applicant: Dell Products L.P., Round Rock, TX (US)

(72) Inventors: Mihai Lazar, Nepean (CA); Ramesh Ganapathi, Chennai (IN); Maithili Selvaraju, Chennai (IN)

(21) Appl. No.: 19/096,996

(22) Filed: Apr. 1, 2025

(51) Int. Cl. H04L 41/082; G06F 16/901

(52) U.S. Cl. CPC H04L 41/082; G06F 16/9024

(57) ABSTRACT

The subject technology relates to configuration consistency maintenance during data center component upgrades. An example method for configuration consistency maintenance during data center component upgrades includes constructing, by a first system, a graph with nodes representative of configuration parameters associated with computing components of a second system, and edges representative of dependencies between respective ones of the configuration parameters; updating, by the first system, a first computing component of the computing components, the updating including altering a first configuration parameter of the configuration parameters and associated with the first computing component; and, in response to the updating being determined to have been completed, modifying, by the first system, a second configuration parameter, of the configuration parameters and associated with a second computing component of the computing components, based on the graph indicating a dependency, of the dependencies, between the first configuration parameter and the second configuration parameter.

### BACKGROUND

Current telecommunications system deployments, such as those utilizing Fifth Generation (5G) wireless standards, can make extensive use of computing servers for executing containerized workloads. For instance, a gNodeB (gNB), which serves as a base station in 5G, can use multiple servers and/or server clusters to realize centralized unit (CU) and/or distributed unit (DU) functionality. Other elements of a wireless communication network, such as at the core network and/or radio access network levels, can also use servers and/or server clusters to implement their respective functionality. A typical telecommunications deployment can include thousands of servers, deployed at various locations (e.g., data centers, cell sites, etc.), and these locations can be interconnected through network links of various characteristics (throughput, latency, reliability, etc.). Generally, these servers and/or other associated devices (e.g., routers, storage devices, etc.) are individually updated and/or configured, e.g., based on the characteristics of a given device.

### SUMMARY

The following summary is a general overview of various embodiments disclosed herein and is not intended to be exhaustive or limiting upon the disclosed embodiments. Embodiments are better understood upon consideration of the detailed description below in conjunction with the accompanying drawings and claims.

In an implementation, a system is described herein. The system can include at least one processor and at least one memory that stores executable instructions that, when executed by the at least one processor, facilitate performance of operations. The operations can include constructing a graph structure with nodes representative of configuration parameters associated with components of a computing system, and edges representative of dependencies between respective ones of the configuration parameters. The operations can also include updating a first component of the components of the computing system, the updating of the first component including altering a first configuration parameter of the configuration parameters and associated with the first component. The operations can further include, in response to the updating of the first component, modifying a second configuration parameter, of the configuration parameters and associated with a second component of the components of the computing system, based on the graph structure indicating a dependency, of the dependencies, between the first configuration parameter and the second configuration parameter.

In another implementation, a method is described herein. The method can include constructing, by a first system including at least one processor, a graph having nodes representative of configuration parameters associated with computing components of a second system, and edges representative of dependencies between respective ones of the configuration parameters. The method can further include updating, by the first system, a first computing component of the computing components of the second system, the updating including altering a first configuration parameter of the configuration parameters and associated with the first computing component. The method can additionally include, in response to the updating being determined to have been completed, modifying, by the first system, a second configuration parameter, of the configuration parameters and associated with a second computing component of the computing components of the second system, based on the graph indicating a dependency, of the dependencies, between the first configuration parameter and the second configuration parameter.

In an additional implementation, a non-transitory machine-readable medium is described herein that can include instructions that, when executed by at least one processor, facilitate performance of operations. The operations can include generating a graph with nodes representative of configuration settings associated with components of a computing system, and edges representative of relationships between respective ones of the configuration settings, where the components of the computing system can include application components, operating system components, and/or hardware components; updating a first one of the components of the computing system, the updating including modifying a first configuration setting of the configuration settings and associated with the first one of the components; and, in response to the updating, modifying a second configuration setting, of the configuration settings and associated with a second one of the components of the computing system, based on the graph indicating a relationship, of the relationships, between the first configuration setting and the second configuration setting.

### DESCRIPTION OF DRAWINGS

Various non-limiting embodiments of the subject disclosure are described with reference to the following figures, wherein like reference numerals refer to like parts throughout unless otherwise specified.

FIG. 1 is a block diagram of a system that facilitates configuration consistency maintenance during data center component upgrades in accordance with various implementations described herein.

FIGS. 2-3 are diagrams depicting dependencies associated with an example data center component upgrade that can be performed in connection with one or more implementations described herein.

FIG. 4 is a block diagram of another system that facilitates configuration consistency maintenance during data center component upgrades in accordance with various implementations described herein.

FIGS. 5-7 are diagrams depicting example graph structures that can be constructed in accordance with various implementations described herein.

FIG. 8 is a block diagram of still another system that facilitates configuration consistency maintenance during data center component upgrades in accordance with various implementations described herein.

FIGS. 9A-9B are diagrams illustrating an example component upgrade procedure that can be performed in connection with one or more implementations described herein.

FIG. 10 is a block diagram of an additional system that facilitates configuration consistency maintenance during data center component upgrades in accordance with various implementations described herein.

FIGS. 11-12 are flow diagrams of respective methods that facilitate soft quotas for cloud resource management in accordance with various implementations described herein.

FIG. 13 is a diagram of an example computing environment in which various implementations described herein can function.

### DETAILED DESCRIPTION

Various specific details of the disclosed embodiments are provided in the description below. One skilled in the art will recognize, however, that the techniques described herein can in some cases be practiced without one or more of the specific details, or with other methods, components, materials, etc. In other instances, well-known structures, materials, or operations are not shown or described in detail to avoid obscuring subject matter.

As noted above, current telecommunications system deployments can make extensive use of computing servers for data processing. For instance, new Fifth Generation (5G) standards deployments, both for the 5G core network and radio access network (RAN), can make use of off-the-shell computing servers for executing 5G workloads, e.g., in Kubernetes clusters. As additionally noted above, a typical telecommunications deployment can include thousands of interconnected servers. These servers can be characterized by their hardware attributes (e.g., compute power/central processing unit (CPU) specifications, memory size, storage size, network bandwidth, etc.) and the software executed by the servers. This software can include, e.g., basic input/output system (BIOS), device drivers and/or firmware for storage, network interface cards, or other devices, a runtime platform (e.g., including an operating system (OS), Kubernetes, etc.), 5G software applications and/or other applications, or other suitable software components.

As communication service providers (CSPs) move from legacy telecommunications solutions to modern cloud-native, open, disaggregated solution architectures such as those described above, it is desirable to provide options that preserve choice, yet offer a reliable, total cost of ownership (TCO)-efficient foundation to build upon. While 5G poses a great opportunity for CSPs to offer new services and applications, it also brings new challenges due to its scale. One of the primary challenges in this area involves lifecycle management of the firmware(s) of the servers in a given deployment. Maintaining up-to-date firmware, e.g., with all security patches along with the latest features in production, can present significant challenges to CSPs.

For instance, when deploying new software or upgrading software associated with a telecommunications deployment, a CSP generally uses a continuous integration/continuous delivery (CI/CD) pipeline to perform the initial deployment, testing, and upgrades of the production environment. During these processes, it is desirable to maintain a minimum level of service associated with the underlying communication network, e.g., such that service level agreement (SLA) parameters are not affected. However, in many cases, a telecommunication deployment involves a heterogeneous set of servers with different hardware and software characteristics, in which software and/or firmware components can be provided by many different vendors. Additionally, application software vendors can perform their own validation on a given software lineup.

For the above and/or other reasons, it can be difficult in most cases to determine the parameter configuration changes to be made to accommodate updated firmware(s) for a given type of server, containers-as-a-service (CaaS) instance, or workload for a given deployment. As a result, it can be prohibitively difficult for CSPs to plan a maintenance window for firmware upgrades without impacting SLAs. The current mode of slow, labor-intensive lifecycle management in a distributed scaled environment can negatively impact the advantages in cost, agility, and scalability that modern telecommunications technologies can provide. For example, as a result of the upgrade of a given software or hardware component, a configuration parameter associated with that component could change, split and/or otherwise be replaced with multiple configuration parameters, or be deprecated and/or otherwise be combined with other configuration parameters. Each of these changes can impact not only the upgraded component itself but also other related components, as will be described in further detail below.

Various implementations as described herein can improve the process of upgrading components of a data center environment and/or other suitable computing environment that includes potentially large numbers of heterogeneous devices and/or components. While various implementations are described herein with reference to examples involving data centers associated with telecommunications systems, it is noted that these examples are provided merely for explanatory purposes and that the concepts described herein can be applied to upgrades within any suitable data center environment without departing from the scope of this description or the claimed subject matter.

In addition, by utilizing one or more implementations as described herein, upgrades to respective data center components can be facilitated using automated processes that can operate at a higher level of complexity than is possible to be performed manually by a human, e.g., due to the number of calculations and/or other operations performed in parallel, the number of components that can be processed simultaneously, and/or other factors. Additionally, implementations described herein can facilitate automation of highly technical tasks that are inherently and/or inextricably tied to computer technology and cannot be implemented outside of a computing environment, such as tasks associated with hardware or software configuration management and/or other aspects of computing system management. As a result, by utilizing one or more automated techniques facilitated by implementations described herein, an end user can be given the ability to perform system upgrade tasks in a data center environment, e.g., by simply pressing a button on a user interface, inputting a simple command, or performing other comparable actions, even if that user lacks the requisite knowledge to perform those tasks manually.

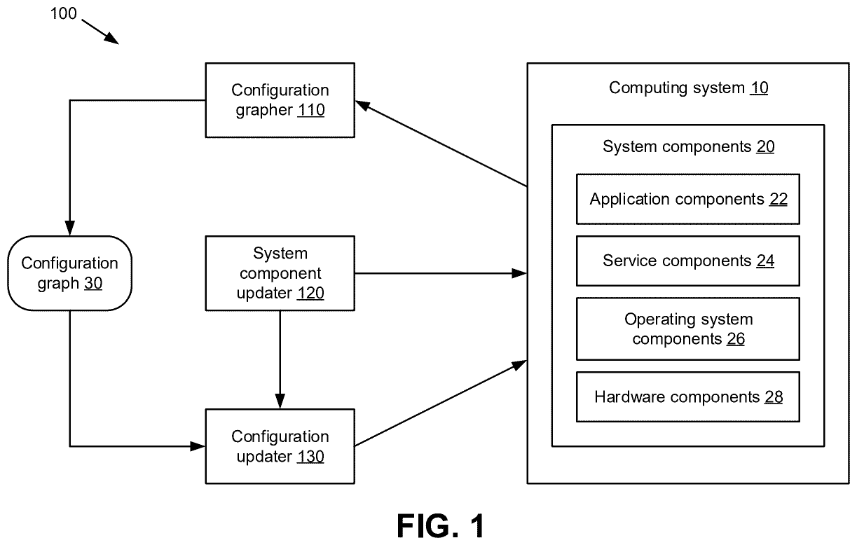

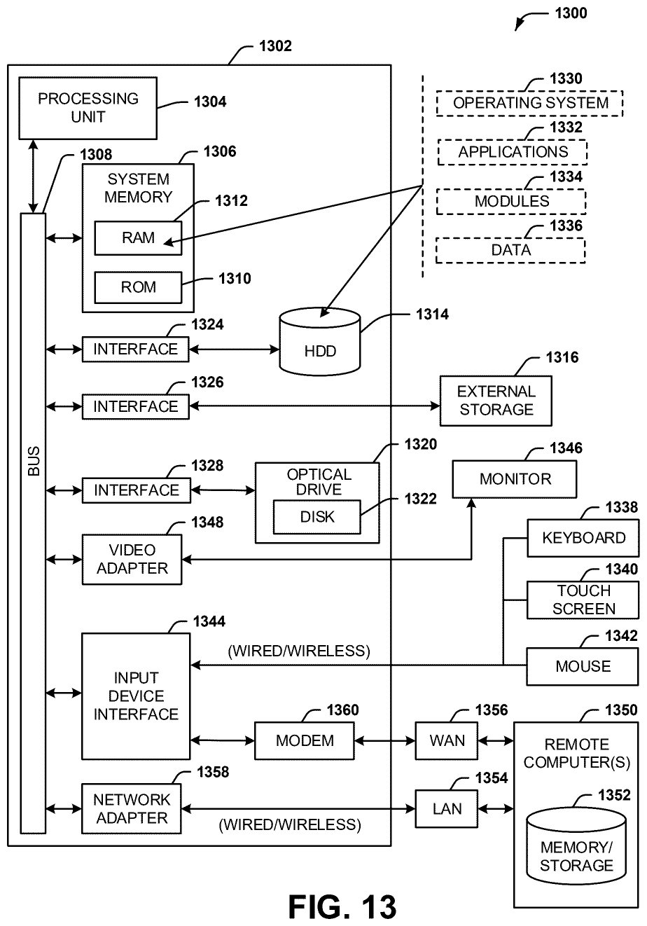

With reference now to the drawings, FIG. 1 illustrates a block diagram of a system 100 that facilitates configuration consistency maintenance during data center component upgrades in accordance with various implementations described herein. System 100 as shown in FIG. 1 includes executable components, e.g., a configuration grapher 110, a system component updater 120, and a configuration updater 130, each of which can operate as described in further detail below. In an implementation, the components 110, 120, 130 of system 100 can be implemented in hardware, software, or a combination of hardware and software. By way of example, the components 110, 120, 130 can be stored on at least one memory and executed by at least one processor. An example of a computer architecture including a processor and memory that can be used to implement the components 110, 120, 130, as well as other components as will be described herein, is shown and described in further detail below with respect to FIG. 13.

Additionally, it is noted that the functionality of the respective components shown and described herein can be implemented via a single computing device and/or a combination of devices. For instance, in various implementations, the configuration grapher 110 shown in FIG. 1 could be implemented via a first device, the system component updater 120 could be implemented via the first device or a second device, and the configuration updater 130 could be implemented via the first device, the second device, or a third device. Also, or alternatively, the functionality of a single component could be divided among multiple devices in some implementations.

As will be described in further detail below, the components 110, 120, 130 of system 100 can be utilized to manage upgrades and/or other configuration changes associated with a computing system 10. The computing system 10 is shown in FIG. 1 and other drawings herein as a single functional block for simplicity, but it is noted that the computing system 10, as illustrated, can be representative of a data center environment and/or other suitable computing environment that can potentially include large numbers of computing devices (e.g., servers, network switches or routers, storage devices, etc.). In some implementations, the components 110, 120, 130, and/or other components as will be described below, can be implemented via one or more devices of the computing system 10 and/or one or more external devices that can communicate with the computing system 10 via any suitable wired and/or wireless communication technology(-ies).

As further shown by FIG. 1, system 100 can facilitate updating, configuring, and/or other otherwise managing respective system components 20 of the computing system 10. These system components 20 can include, but are not necessarily limited to, application components 22 (e.g., corresponding to software applications or other workloads running on the computing system 10), service components 24 (e.g., corresponding to containerized services, such as those operating according to a CaaS model or the like), operating system components 26 (e.g., corresponding to operating systems, or operating system functions, running on the computing system 10), hardware components 28 (e.g., corresponding to hardware devices associated with the computing system 10 and/or their firmware), and/or other suitable components.

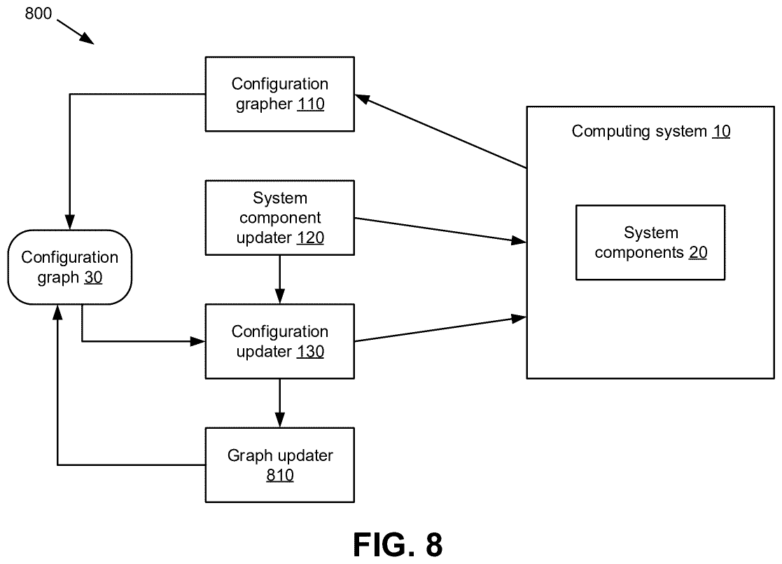

With reference now to the components of system 100, the configuration grapher 110 of system 100 can construct a graph structure, e.g., the configuration graph 30 shown in FIG. 1, that includes nodes representative of configuration parameters (settings) associated with respective system components 20 of the computing system 10, as well as edges representative of dependencies, or other relationships, between those configuration parameters. An example configuration graph 30 that can be constructed by the configuration grapher 110 is described in further detail below with respect to FIG. 7.

The system component updater 120 of system 100 can update a component of the system components 20 of the computing system 10, i.e., a first component. As part of this update, the system component updater 120 can alter a configuration parameter (i.e., a first configuration parameter) of the configuration parameters associated with the first component.

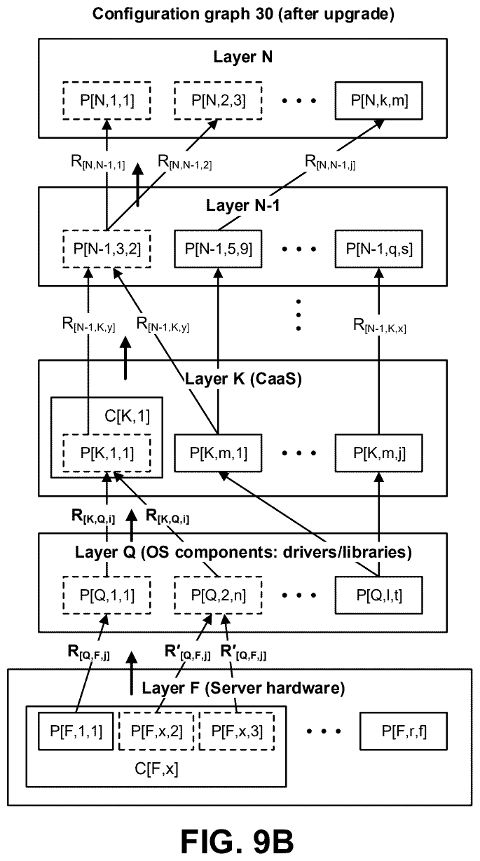

In response to the system component updater 120 updating the first component of the computing system 10, the configuration updater 130 of system 100 can modify a configuration parameter of a different one of the system components 20, i.e., a second configuration parameter of a second component, based on the configuration graph 30 constructed by the configuration grapher 110 indicating a dependency or other relationship between the first configuration parameter and the second configuration parameter. This process is described in further detail below with respect to FIGS. 9A-9B.

By utilizing system 100 to perform upgrades to system components 20 of the computing system 10, the overall process can be made more robust and resilient to complications that may occur during the upgrade process. For instance, handling of a given upgrade could depend on factors such as firmware dependencies between different firmware components; the potential that a given upgrade may need to be performed as a step upgrade, in which a firmware component is upgraded in stages rather than as a single upgrade in order to mitigate risks, ensure compatibility, reduce downtime, or for other purposes; security vulnerabilities or other issues of a given firmware version to be addressed by an upgrade; configuration parameters of different, unrelated components that are impacted by a firmware upgrade to a given component; and/or other factors.

In addition, system 100 can be utilized to handle configuration dependencies during an upgrade, which could result in issues such as mutually exclusive parameter values, conflicting configurations, or the like if not addressed. Potential causes of these issues can range from simple configuration changes, such as adding a new parameter, converting an existing parameter to a new parameter, or the like, to more complex configuration changes, such as dividing a parameter into multiple parameters or a set of multiple parameters being combined into a single parameter. As an example of the former, a global maximum connections parameter, e.g., “max_connections=500,” could be divided into multiple parameters that define categories of connections, e.g., “max_user_connections=300,” “max_admin_connections=50,” and “max_background_connections=150.” As an example of the latter, a group of per-core processor capacity parameters associated with a central processing unit (CPU), e.g., “capacity_CPU0,” “capacity_CPU1,” etc., could be merged into a single parameter for the CPU, e.g., “capacity_CPU_total.” Other examples are also possible. To compound these issues, a computing system 10 can include many heterogeneous system components 20 associated with multiple vendors, such as workload/application vendors, CaaS vendors, original equipment manufacturer (OEM) vendors, and/or other vendors or sources.

Additionally, when a system component 20 is upgraded, it is desirable to keep its configuration compatible with other system components 20 of the computing system 10; otherwise, it can create adverse impacts to the upgraded component itself and/or other components dependent on that component. In this context, keeping a configuration “compatible” means ensuring that any changes to the configuration, such as changing, dividing, or merging parameters, do not cause malfunctions to any associated or related components. Stated another way, for a group of component configurations [M, N, P] prior to an upgrade, a corresponding group of component configurations [M′, N′, P′] after the upgrade are compatible with the previous configurations if users of those components do not perceive any unintended changes to system behavior (i.e., excluding intended changes such as new features or the like) after the upgrade.

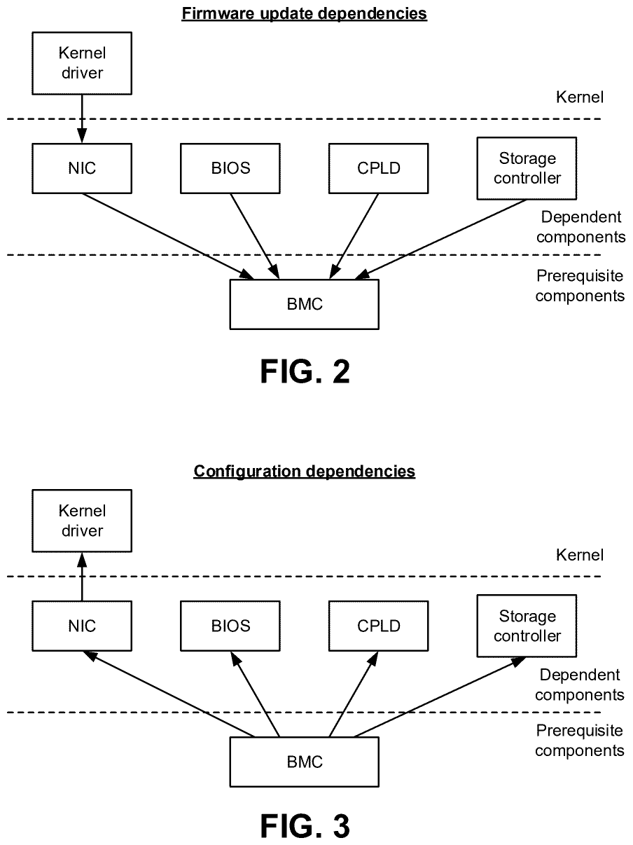

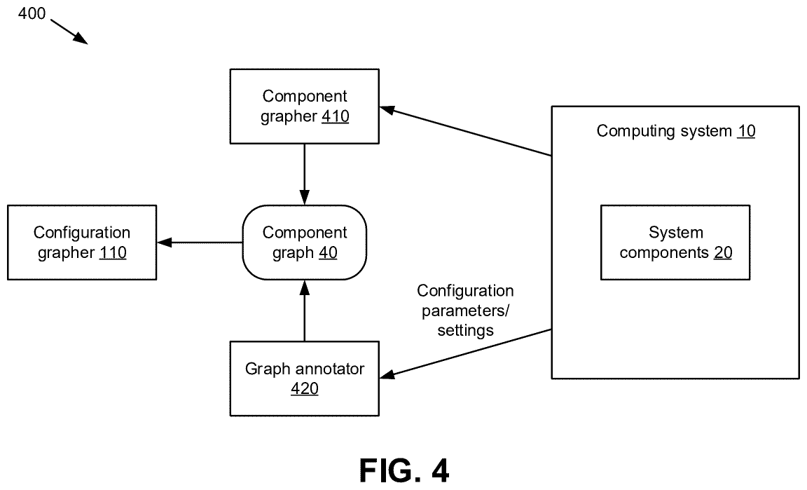

As an example of inter-related system components 20 that can coexist in a computing system 10, FIGS. 2-3 illustrate component (firmware update) dependencies and configuration dependencies, respectively, that can occur in an example system that includes a kernel driver, a network interface controller (NIC), a basic input/output system (BIOS), a complex programmable logic device (CPLD), a storage controller, and a baseboard management controller (BMC). The firmware update dependencies shown in FIG. 2 illustrate that updating the firmware of the BMC inherently requires similar component firmware updates to its dependent components, e.g., the NIC, BIOS, CPLD, and storage controller. However, as shown by FIG. 3, any updates to the configuration of the illustrated dependent components to the BMC must remain compatible with the configuration of the BMC to avoid component malfunctions. Thus, by way of example, if upgrading the firmware of the BMC to version N requires the BIOS firmware to be upgraded from version M−1 to version M, any changes to the configuration of the BIOS resulting from moving from version M−1 to version M should remain compatible with the BMC configuration.

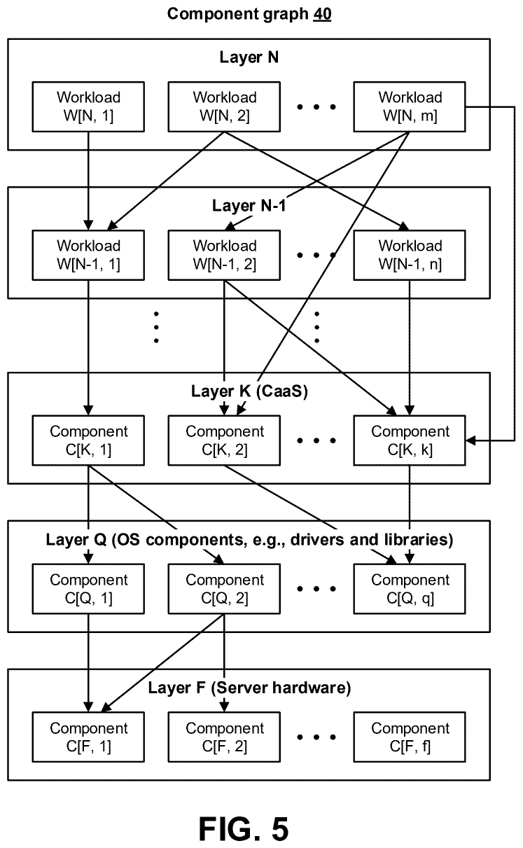

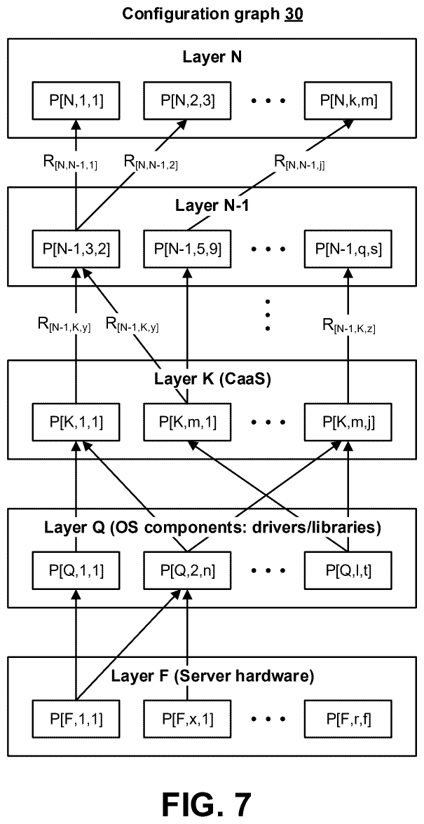

In view of at least the above, implementations described herein can automatically adjust the configuration parameters of computing components, e.g., software and/or firmware components, to maintain configuration consistency after an upgrade. An overview of an example process that can be performed by various implementations as described herein to this end is as follows. First, as will be described in further detail below with respect to FIGS. 4, the components and/or workloads associated with a system can be determined and organized, e.g., as respective layers. The organization of the components and/or workloads within respective layers can be based on dependencies between the components and/or workloads. The determined components and/or workloads of the system, as well as their layer structure, can then be utilized to build a graph structure, such as a directed acyclic graph (DAG), representative of the components and/or workloads. An example of a DAG that can be utilized for this purpose is described in further detail below with respect to FIG. 6.

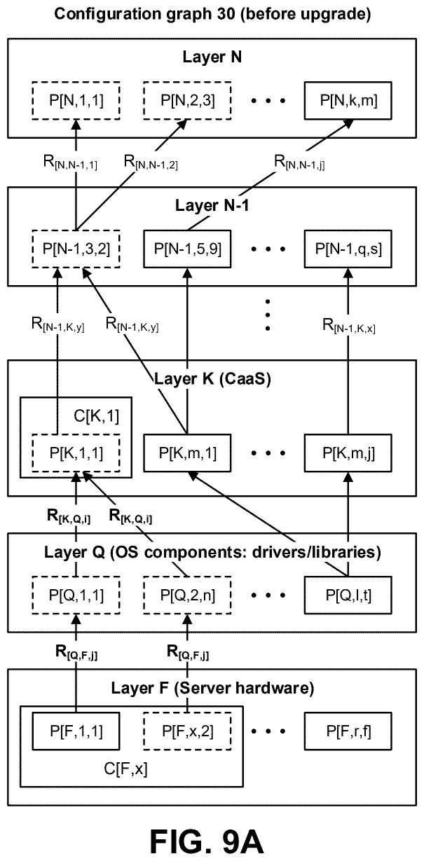

Next, as will also be discussed in further detail below with respect to FIG. 4, the configuration parameters for each component and/or workload can be determined, and these parameters can be added as annotations to the DAG, as will be described in further detail below with respect to FIG. 6. Following this annotation, another graph structure, e.g., a reverse DAG or rDAG, can be constructed (e.g., by system 100 as described above with respect to FIG. 1) to describe how parameters associated with lower system layers impact parameters on the layers above. An example of an rDAG that can be constructed in this manner is described in further detail below with respect to FIG. 7. Finally, as will be described in further detail below with respect to FIGS. 8 and 9A-9B, modifications to parameters on upper layers can be determined to maintain compatibility with upgrades of components on lower layers. At this stage, the rDAG can be used to calculate the new values to be applied to the configuration parameters of an upgraded system component and/or any dependent system components. As will be described below, this process can also support upgrades of multiple components at the same upgrade stage.

With reference now to FIG. 4, a block diagram of another system 400 that facilitates configuration consistency maintenance during data center component upgrades is illustrated. Repetitive description of like parts described above with regard to other implementations is omitted for brevity. System 400 as shown in FIG. 4 includes a component grapher 410, which can, prior to the configuration grapher 110 constructing a configuration graph 30 (not shown in FIG. 4) as described above with reference to FIG. 1, construct a second graph structure, e.g., a component graph 40 as shown in FIG. 4. The component graph 40 can include nodes that are representative of system components 20 of an associated computing system 10, as well as edges that are representative of dependencies and/or other relationships between the system components 20 represented as nodes in the component graph 40.

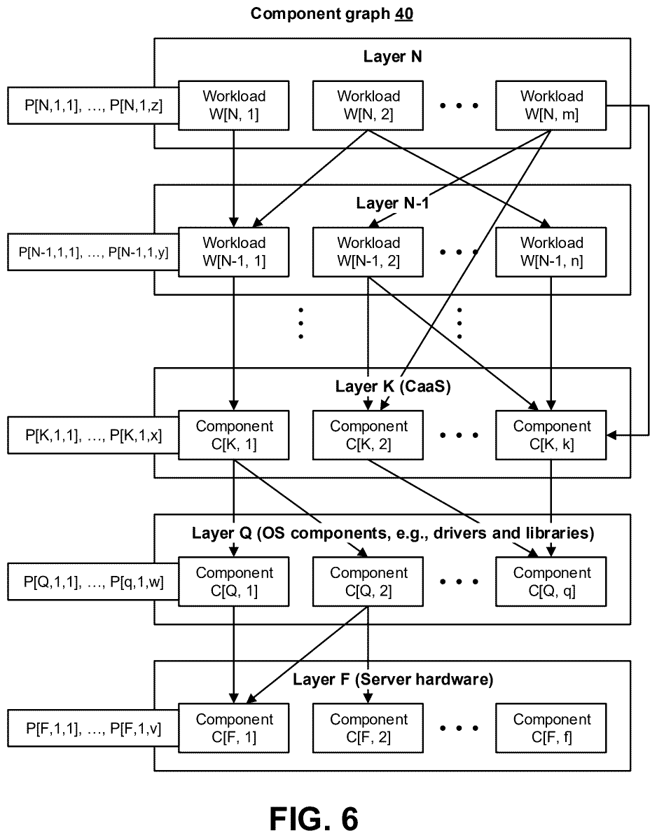

In an implementation, the nodes of the component graph 40 constructed by the component grapher 410 can be arranged in layers, e.g., as shown by the example component graph 40 in FIG. 5. As FIG. 5 illustrates, respective layers of the component graph 40 can include one or more layers corresponding to application components (e.g., workloads) of a computing system, denoted in FIG. 5 as layers N, N−1, and so on. The layers of the component graph 40 shown in FIG. 5 can further include a layer corresponding to service components (e.g., CaaS components), denoted in FIG. 5 as layer K; a layer corresponding to OS components, denoted in FIG. 5 as layer Q, and a layer corresponding to hardware/firmware components, denoted in FIG. 5 as layer F. Other layers could also be used.

As shown in FIG. 5, a software system (e.g., associated with a data center and/or other suitable computing deployment) can be organized as multiple layers (N, N−1, . . . ), with each layer composed of respective workloads (applications). As shown in FIG. 5, workloads in the component graph 40 can be denoted as W[A, B], where A represents the layer in which the workload is located and B is an index of the workload within its layer. Without loss of generality, the component graph 40 can be structured such that workloads at layer N depend only on workloads at layer N−1 and below, i.e., the workloads in the respective software layers exhibit hierarchical dependencies. Accordingly, the component grapher 410 can construct the component graph 40 such that all applications in layer N depend only on applications at layer N−1 and below, all applications in layer N−1 depend only on applications at layer N−2 and below, and so on.

In an implementation, the structure of the software layers N, N−1, etc., can be derived from a dependency graph of the applications resident in a given system. By way of a non-limiting example associated with a Linux-based system, this can be obtained using tools such as the Debian debtree command, which can be used to obtain information relating to application package dependencies associated with applications in the software layers. Other tools for determining dependencies between applications and/or workflows in the software layers could also be used. Dependencies involving lower layers, such as layers K, Q and F shown in FIG. 5, can be inferred by the component grapher 410 based on the system hardware properties. As a result of these operations, the component grapher 410 can model the components of a system and their dependencies as a DAG, e.g., as shown by FIG. 5.

Returning now to FIG. 4, after the component grapher 410 has successfully constructed a component graph 40 representative of the system components 20 of the computing system 10, a graph annotator 420 can apply annotations to respective nodes of the component graph 40. These annotations can be representative of configuration parameters that are associated with system components 20 of the computing system 10 that correspond to the respective nodes of the component graph 40. The configuration grapher 110 can then utilize these annotations to construct a configuration graph 30, e.g., as described above with reference to FIG. 1.

An example of annotations that can be applied by the graph annotator 420 of system 400 is shown in FIG. 6. As FIG. 6 illustrates, the graph annotator 420 can annotate all workload and component nodes in the component graph 40 with their respective configuration parameters P[n, w, p], where n is the layer index, w is the index of the application or component within layer n, and p is the parameter index of the parameter within the application or component w. While only one component in each layer is shown as annotated in FIG. 6 due to space constraints, it is noted that each component of the component graph 40 can be annotated by the graph annotator 420 in a similar manner to those shown in FIG. 6.

Using the annotations applied to the component graph 40 by the graph annotator 420, the configuration grapher 110 can construct a configuration graph 30 that represents the effect of configuration changes of lower layer components on upper layer components. In an implementation, the configuration grapher 110 can build the configuration graph 30 as a “reverse” DAG, or rDAG, as shown in FIG. 7. The terminology “reverse DAG” is used to contrast the relationships in the configuration graph 30 from those in the component graph 40, e.g., as the relationships in the configuration graph 30 flow in the reverse direction compared to those in the component graph 40.

As shown in FIG. 7, the rDAG can represent the constraints that parameters on lower layers impose on parameters in upper layers. Stated another way with reference to the configuration graph 30 shown in FIG. 7, the rDAG can represent how the parameters of components of layers N−1 and below constrain the values of the parameters of components of layer N, and so on. These constraints are represented in the rDAG as graph edges, and each edge in the rDAG can be labeled by the configuration grapher 110 with their respective constraints (relationships). As shown in FIG. 7, these labels can take the form R_{[M, N, r]} for a relationship between parameters on layers M and N, where r is relationship index expressed as a number from 1 to W_{[N, M]}, where W_{[N, M]} is the total number of relationships between parameters on layers M and N. In an implementation, the configuration grapher 110 can infer constraints and/or other relationships between parameters on respective layers based on the way the parameters are structured, the parameters themselves, and/or by other suitable means. By way of a specific example, a configuration parameter in layer F corresponding to a maximum NIC connection rate, or other suitable parameter, can be regarded by the configuration grapher 110 as related to maximum data rate parameters, or other network-related parameters, of components in higher layers.

In some cases, the same relationship can be associated with multiple edges of the rDAG, e.g., in the event that a parameter is constrained or otherwise impacted by two or more parameters of components in lower layers, in which case the same relationship label can be applied to all relevant edges. For instance, as shown in layers K and N−1 of the configuration graph 30 in FIG. 7, parameter P[N−1, 3, 2], corresponding to the second parameter of the third application of layer N−1, is constrained by both P[K, 1, 1] and P[K, m, 1], corresponding to the first parameters of the first and m-th components of layer K, respectively. In this case, both of these dependencies can be represented using a common relationship index, e.g., R_{[N-1, K, y]}.

Referring next to FIG. 8, a block diagram of a further system 800 that facilitates configuration consistency maintenance during data center component upgrades is illustrated. Repetitive description of like parts described above with regard to other implementations is omitted for brevity. System 800, as shown in FIG. 8, includes a configuration grapher 110 that can build a configuration graph 30 corresponding to a computing system 10, e.g., as generally described above.

As a result of updates to system components 20 of the computing system 10 made by the system component updater 120, the configuration updater 130, based on the configuration graph 30, can make appropriate changes to configuration parameters or settings of the system components 20. For instance, in the event that the system component updater 120 applies an update to a system component 20 that imposes a constraint on configuration parameters of the upgraded component and/or related components, the configuration updater 130 can modify configuration parameters of the upgraded component and/or the related components to conform those configuration parameters to the added constraint. By way of specific, non-limiting example with reference to the configuration graph 30 shown in FIG. 7, for a configuration parameter in layer F associated with the Ethernet maximum transmission unit (MTU) size supported by a NIC, the configuration parameters of all layers that depend on the NIC firmware can be dependent on the Ethernet MTU size parameter of the NIC, e.g., such that no MTU parameter in any layer can exceed the MTU specified via the NIC firmware. This can be expressed mathematically as MTU_{N}≤MTU_{N-1}≤ . . . ≤MTU_{Q}≤max(MTU_{F}), where MTU_{X} represents the MTU associated with layer X. Accordingly, if an upgrade results in the NIC MTU size decreasing to a given value (e.g., due to the introduction of a new protocol field and/or other reasons), the decrease can be propagated by the configuration updater 130 to the MTU configuration of all related components and/or workloads.

As further shown in FIG. 8, system 800 includes a graph updater 810 that can update the configuration graph 30 as desired based on changes to the configuration parameters of system components 20 of the computing system 10, e.g., resulting from updates to those components. For instance, the graph updater 810 can modify the configuration graph 30 based on alterations to dependencies between respective configuration parameters. In some cases, these dependencies and/or other relationships can be changed, added, or eliminated as a result of a component upgrade. In still other cases, parameters of an upgraded component can be added or removed, with the corresponding impact on their relationships. By way of example, an update applied to a system component 20 can cause a configuration parameter of that component to be divided into a group of parameters. In response to this division, the graph updater 810 can divide a node of the configuration graph 30 that corresponds to the original parameter into a group of nodes that correspond to respective ones of the group of parameters resulting from the split. In other example, an update applied to a system component 20 can cause a group of configuration parameters associated with that component to be merged into a single parameter. In such a case, the graph updater 810 can similarly merge nodes of the configuration graph 30 to account for the merge, along with altering any edges of the configuration graph 30 as needed to reflect resulting updates to parameter relationships.

Referring next to FIGS. 9A-9B, and with additional reference to FIG. 8, example modifications to a configuration graph 30 that can be made by the graph updater 810 in response to an upgrade of one or more system components 20 of a computing system 10 (e.g., via the system component updater 120) are shown. FIG. 9A illustrates the state of the configuration graph 30 prior to the upgrade, while FIG. 9B illustrates the state of the configuration graph 30 after the upgrade.

In the example upgrade shown by FIGS. 9A-9B, two components are upgraded: component C[F, x], which includes parameters P[F, x, 1] and P[F, x, 2], and component C[K, 1], which includes parameter P[K, 1, 1]. It is noted that the components and parameters shown in FIGS. 9A-9B are intended merely by way of non-limiting example and that components could have more parameters than that shown by FIGS. 9A-9B. As a result of the upgrade, the parameter P[F, x, 2] is split into two parameters, shown in FIG. 9B as parameters P′[F, x, 2] and P′[F, x, 3]. In some implementations, rules by which these new parameters can be created and assigned values can be applied to facilitate automation. However, as further shown by FIG. 9B, parameter P[Q, 2, m] is constrained by the new parameters through a new relationship, denoted as R′_{[Q, F, j]}, versus relationship R_{[Q, F, j]} prior to the upgrade as shown by FIG. 9A.

In view of the above, system 800 can automate the upgrade process as follows:
1) For each upgraded component, determine the new parameters and their new values.
2) Determine the new relationships, if any, that are introduced by the upgrade and update the configuration graph 30.
3) Starting from the lowest upgraded component and its new parameters, traverse the edges of the configuration graph 30 and recalculate the values of high-level parameters, e.g., such that the high-level parameters are consistent with the relationships applied to both the new values of the low-level parameters and the constraints imposed by the high-level component itself.
4) Repeat step 3 until all parameters are recalculated.

As further shown by FIGS. 9A-9B, system 800 can maintain the consistency of configuration parameters across components even in the event that components in multiple layers are updated simultaneously (or near simultaneously, e.g., as part of a common upgrade operation). For instance, the system component updater 120 of system 800 can perform a component upgrade (e.g., an upgrade to component C[F, x]) concurrently with upgrades to other components (e.g., an upgrade to component C[K, 1]). Based on these concurrent upgrades, the configuration updater 130 of system 800 can perform multiple concurrent groups of parameter modifications, e.g., by modifying parameters in upper layers of the configuration graph 30 based on relationships between the modified lower-layer parameters and those upper-layer parameters.

In general, the system component updater 120 can upgrade components on lower layers of the configuration graph 30, based on which the configuration updater 130 can modify configuration parameters for the upgraded components as appropriate. Subsequently, the configuration updater 130 can iteratively apply changes to parameters on higher layers of the configuration graph 30, effectively propagating the parameter modifications up the layers of the system. In this way, the configuration updater 130 can facilitate a bottom-up approach to parameter modification, in which changes to lower level parameters cause corresponding changes to parameters on higher layers based on defined relationships.

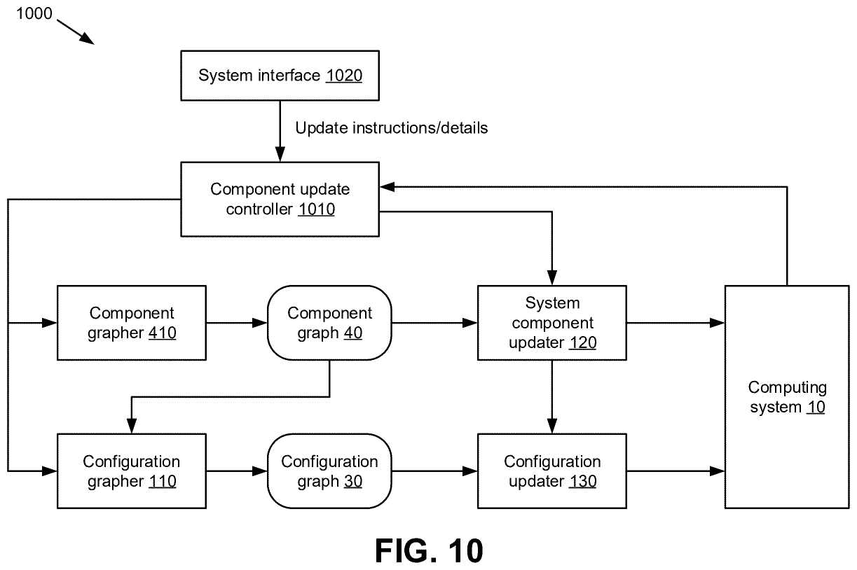

Referring next to FIG. 10, a system 1000 that can be used to control and/or otherwise manage updates to components and/or configurations in a computing system 10 is illustrated. Repetitive description of like parts described above with regard to other implementations is omitted for brevity. System 1000 includes a component update controller 1010 that can manage updates to components of a computing system 10, e.g., by coordinating operation of one or more elements described herein (e.g., the configuration grapher 110, system component updater 120, configuration updater 130, component grapher 410, and/or other elements described herein). In an implementation, the component update controller 1010 can be implemented as part of an orchestrator system that manages the computing system 10 and/or its respective computing components. In some implementations, the component update controller 1010 can be implemented on the computing system 10 itself. Alternatively, the component update controller 1010 can be implemented via one or more computing devices that are separate from the computing system 10 and communicatively coupled to the computing system 10 via one or more wired or wireless communication technologies.

As further shown in FIG. 10, the component update controller 1010 can receive instructions and/or other information, e.g., from a system administrator or other system user, via a system interface 1020. In an implementation, the system interface 1020 can enable granular and complex control of the components of an associated computing system 10 via simplified commands and/or other actions that do not require a user of the system interface 1020 have specific knowledge regarding the computing system 10 and/or its components or control procedures. By way of example, the system interface 1020 can enable a user to initiate a component upgrade within the computing system 10 by merely indicating the component(s) to be upgraded and/or target software/firmware version(s) to be applied via the upgrade. Based on this simplified input, the component update controller 1010 can then automatically orchestrate the desired upgrade(s), including determining and performing configuration changes, determining an order of upgrades to be performed, managing system restarts, step upgrades, and/or any other intermediate upgrade steps as they occur, or the like.

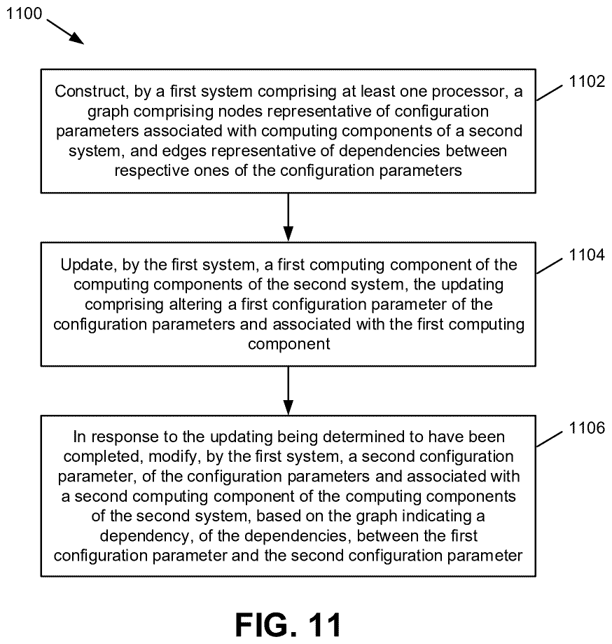

Turning to FIG. 11, a flow diagram of a method 1100 that facilitates configuration consistency maintenance during data center component upgrades is illustrated. At 1102, a first system comprising at least one processor can construct (e.g., by a configuration grapher 110) a graph (e.g., a configuration graph 30) comprising nodes representative of configuration parameters associated with computing components (e.g., system components 20) of a second system (e.g., a computing system 10), and edges representative of dependencies between respective ones of the configuration parameters.

At 1104, the first system can update (e.g., by a system component updater 120) a first computing component of the computing components of the second system. This updating can include altering a first configuration parameter of the configuration parameters and associated with the first computing component.

At 1106, in response to the updating at 1104 being determined to have been completed, the first system can modify (e.g., by a configuration updater 130) a second configuration parameter, of the configuration parameters represented in the graph constructed at 1102 and associated with a second computing component of the computing components of the second system, based on the graph indicating a dependency, of the dependencies, between the first configuration parameter and the second configuration parameter.

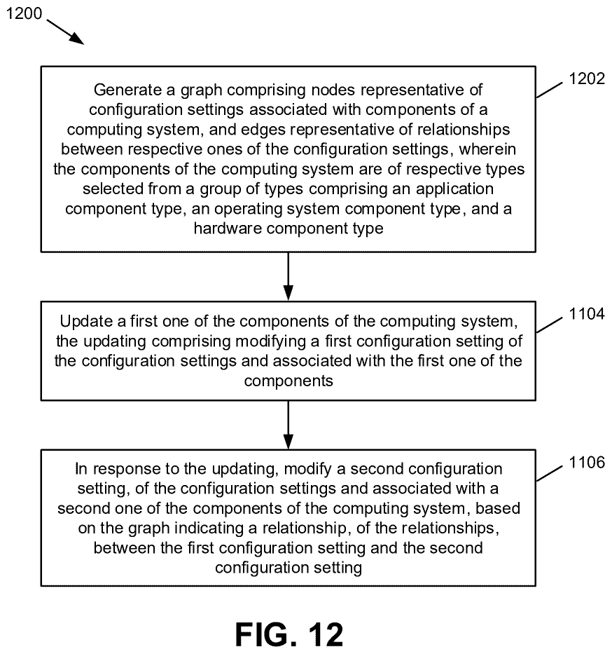

Referring next to FIG. 12, a flow diagram of a method 1200 that can be performed by at least one processor, e.g., based on machine-executable instructions stored on a non-transitory machine-readable medium, is illustrated. An example of a computer architecture, including a processor and non-transitory media, which can be utilized to implement method 1000 is described below with respect to FIG. 13.

Method 1200 can begin at 1202, in which the at least one processor can generate a graph comprising nodes representative of configuration settings associated with components of a computing system, and edges representative of relationships between respective ones of the configuration settings. The components of the computing system can be of respective types selected from a group of types comprising an application component type, an operating system component type, and a hardware component type.

At 1204, the at least one processor can update a first one of the components of the computing system, the updating comprising modifying a first configuration setting of the configuration settings and associated with the first one of the components.

At 1206, in response to the updating at 1204, the at least one processor can update a first one of the components of the computing system, the updating comprising modifying a first configuration setting of the configuration settings and associated with the first one of the components.

FIGS. 11-12 as described above illustrate methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

In order to provide additional context for various embodiments described herein, FIG. 13 and the following discussion are intended to provide a brief, general description of a suitable computing environment 1300 in which the various embodiments of the embodiment described herein can be implemented. While implementations have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and include any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference now to FIG. 13, an example general-purpose environment 1300 for implementing various embodiments described herein includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures can also be employed as the processing unit 1304.

The system bus 1308 can be any of several types of bus structure that can further interconnect to a memory bus (with or without a memory controller), a peripheral bus, and a local bus using any of a variety of commercially available bus architectures. The system memory 1306 includes ROM 1310 and RAM 1312. A basic input/output system (BIOS) can be stored in a non-volatile memory such as ROM, erasable programmable read only memory (EPROM), EEPROM, which BIOS contains the basic routines that help to transfer information between elements within the computer 1302, such as during startup. The RAM 1312 can also include a high-speed RAM such as static RAM for caching data.

The computer 1302 further includes an internal hard disk drive (HDD) 1314 (e.g., EIDE, SATA), one or more external storage devices 1316 (e.g., a magnetic floppy disk drive (FDD), a memory stick or flash drive reader, a memory card reader, etc.) and an optical disk drive 1320 (e.g., which can read or write from a CD-ROM disc, a DVD, a BD, etc.). While the internal HDD 1314 is illustrated as located within the computer 1302, the internal HDD 1314 can also be configured for external use in a suitable chassis (not shown). Additionally, while not shown in environment 1300, a solid-state drive (SSD) could be used in addition to, or in place of, an HDD 1314. The HDD 1314, external storage device(s) 1316 and optical disk drive 1320 can be connected to the system bus 1308 by an HDD interface 1324, an external storage interface 1326 and an optical drive interface 1328, respectively. The interface 1324 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1302, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. The systems and methods described herein can be implemented utilizing various commercially available operating systems or combinations of operating systems.

Computer 1302 can optionally comprise emulation technologies. For example, a hypervisor (not shown) or other intermediary can emulate a hardware environment for operating system 1330, and the emulated hardware can optionally be different from the hardware illustrated in FIG. 13. In such an embodiment, operating system 1330 can comprise one virtual machine (VM) of multiple VMs hosted at computer 1302. Furthermore, operating system 1330 can provide runtime environments, such as the Java runtime environment or the .NET framework, for applications 1332. Runtime environments are consistent execution environments that allow applications 1332 to run on any operating system that includes the runtime environment. Similarly, operating system 1330 can support containers, and applications 1332 can be in the form of containers, which are lightweight, standalone, executable packages of software that include, e.g., code, runtime, system tools, system libraries and settings for an application.

Further, computer 1302 can be enabled with a security module, such as a trusted processing module (TPM). For instance, with a TPM, boot components hash next in time boot components and wait for a match of results to secured values before loading a next boot component. This process can take place at any layer in the code execution stack of computer 1302, e.g., applied at the application execution level or at the operating system (OS) kernel level, thereby enabling security at any level of code execution.

A user can enter commands and information into the computer 1302 through one or more wired/wireless input devices, e.g., a keyboard 1338, a touch screen 1340, and a pointing device, such as a mouse 1342. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1304 through an input device interface 1344 that can be coupled to the system bus 1308, but can be connected by other interfaces, such as a parallel port, an IEEE 1394 serial port, a game port, a USB port, an IR interface, a BLUETOOTH® interface, etc.

A monitor 1346 or other type of display device can be also connected to the system bus 1308 via an interface, such as a video adapter 1348. In addition to the monitor 1346, a computer typically includes other peripheral output devices (not shown), such as speakers, printers, etc.

The computer 1302 can operate in a networked environment using logical connections via wired and/or wireless communications to one or more remote computers, such as a remote computer(s) 1350. The remote computer(s) 1350 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1352 is illustrated. The logical connections depicted include wired/wireless connectivity to a local area network (LAN) 1354 and/or larger networks, e.g., a wide area network (WAN) 1356. Such LAN and WAN networking environments are commonplace in offices and companies, and facilitate enterprise-wide computer networks, such as intranets, all of which can connect to a global communications network, e.g., the Internet.

When used in a LAN networking environment, the computer 1302 can be connected to the local network 1354 through a wired and/or wireless communication network interface or adapter 1358. The adapter 1358 can facilitate wired or wireless communication to the LAN 1354, which can also include a wireless access point (AP) disposed thereon for communicating with the adapter 1358 in a wireless mode.

When used in a WAN networking environment, the computer 1302 can include a modem 1360 or can be connected to a communications server on the WAN 1356 via other means for establishing communications over the WAN 1356, such as by way of the Internet. The modem 1360, which can be internal or external and a wired or wireless device, can be connected to the system bus 1308 via the input device interface 1344. In a networked environment, program modules depicted relative to the computer 1302 or portions thereof, can be stored in the remote memory/storage device 1352. It will be appreciated that the network connections shown are examples and other means of establishing a communications link between the computers can be used.

When used in either a LAN or WAN networking environment, the computer 1302 can access cloud storage systems or other network-based storage systems in addition to, or in place of, external storage devices 1316 as described above. Generally, a connection between the computer 1302 and a cloud storage system can be established over a LAN 1354 or WAN 1356 e.g., by the adapter 1358 or modem 1360, respectively. Upon connecting the computer 1302 to an associated cloud storage system, the external storage interface 1326 can, with the aid of the adapter 1358 and/or modem 1360, manage storage provided by the cloud storage system as it would other types of external storage. For instance, the external storage interface 1326 can be configured to provide access to cloud storage sources as if those sources were physically connected to the computer 1302.

The computer 1302 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such a feature may be combined with one or more other features of the other implementations as may be desired and advantageous for any given application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein but rather should be construed in breadth and scope in accordance with the appended claims below.

What is claimed is:

1. A system, comprising:
at least one processor; and
at least one memory that stores executable instructions that, when executed by the at least one processor, facilitate performance of operations, the operations comprising:
constructing a graph structure comprising nodes representative of configuration parameters associated with components of a computing system, and edges representative of dependencies between respective ones of the configuration parameters;
updating a first component of the components of the computing system, the updating of the first component comprising altering a first configuration parameter of the configuration parameters and associated with the first component; and
in response to the updating of the first component, modifying a second configuration parameter, of the configuration parameters and associated with a second component of the components of the computing system, based on the graph structure indicating a dependency, of the dependencies, between the first configuration parameter and the second configuration parameter.

2. The system of claim 1, wherein the graph structure is a first graph structure, wherein the nodes of the first graph structure are first nodes, wherein the edges of the first graph structure are first edges, wherein the dependencies are first dependencies, and wherein the operations further comprise:
prior to constructing the first graph structure, constructing a second graph structure comprising second nodes representative of the components of the computing system, and second edges representative of second dependencies between respective ones of the components of the computing system, wherein the second nodes are arranged in respective layers of the second graph structure based on the second dependencies.

3. The system of claim 2, wherein the operations further comprise:
applying annotations to respective ones of the second nodes of the second graph structure, wherein the annotations are representative of respective ones of the configuration parameters and associated with respective ones of the components of the computing system corresponding to the respective ones of the second nodes, and wherein the constructing of the first graph structure comprises generating the first nodes of the first graph structure based on the annotations.

4. The system of claim 2, wherein the respective layers of the second graph structure comprise one or more first layers corresponding to application components of the computing system, a second layer corresponding to operating system components of the computing system, and a third layer corresponding to hardware components of the computing system.

5. The system of claim 1, wherein the updating of the first component comprises adding a constraint on the first configuration parameter and the second configuration parameter, and wherein the modifying of the second configuration parameter comprises modifying the second configuration parameter to conform the second configuration parameter to the constraint.

6. The system of claim 1, wherein the updating of the first component comprises dividing the first configuration parameter into a group of configuration parameters.

7. The system of claim 6, wherein the operations further comprise:
dividing a node, of the nodes of the graph structure and corresponding to the first configuration parameter, into a group of nodes corresponding to respective ones of the group of configuration parameters.

8. The system of claim 1, wherein the updating of the first component comprises merging the first configuration parameter with a third configuration parameter of the configuration parameters and associated with the first component.

9. The system of claim 1, wherein the operations further comprise:
in further response to the updating of the first component, modifying the graph structure based on alterations, resulting from the updating of the first component, to the dependencies between the respective ones of the configuration parameters.

10. The system of claim 1, wherein the dependency is a first dependency, and wherein the operations further comprise:
updating a third component, of the components of the computing system and distinct from the first component, concurrently with the updating of the first component, the updating of the third component comprising altering a third configuration parameter of the configuration parameters and associated with the third component; and
in response to the updating of the third component, modifying a fourth configuration parameter, of the configuration parameters and associated with a fourth component of the computing system, based on the graph structure indicating a second dependency, of the dependencies, between the third configuration parameter and the fourth configuration parameter.

11. A method, comprising:
constructing, by a first system comprising at least one processor, a graph comprising nodes representative of configuration parameters associated with computing components of a second system, and edges representative of dependencies between respective ones of the configuration parameters;
updating, by the first system, a first computing component of the computing components of the second system, the updating comprising altering a first configuration parameter of the configuration parameters and associated with the first computing component; and
in response to the updating being determined to have been completed, modifying, by the first system, a second configuration parameter, of the configuration parameters and associated with a second computing component of the computing components of the second system, based on the graph indicating a dependency, of the dependencies, between the first configuration parameter and the second configuration parameter.

12. The method of claim 11, wherein the graph is a first graph, wherein the nodes of the first graph are first nodes, wherein the edges of the first graph are first edges, wherein the dependencies are first dependencies, and wherein the method further comprises:
constructing, by the first system, a second graph comprising second nodes representative of the computing components of the second system, and second edges representative of second dependencies between respective ones of the computing components of the second system, wherein the second nodes are arranged in respective layers of the second graph based on the second dependencies.

13. The method of claim 12, further comprising:
applying, by the first system, annotations to respective ones of the second nodes of the second graph, wherein the annotations are representative of respective configuration parameters of the configuration parameters and associated with respective ones of the computing components of the second system corresponding to the respective ones of the second nodes, and wherein the constructing of the first graph comprises generating the first nodes of the first graph based on the annotations.

14. The method of claim 11, wherein the updating comprises imposing a constraint on the first configuration parameter and the second configuration parameter, and wherein the modifying of the second configuration parameter comprises modifying the second configuration parameter to conform the second configuration parameter to the constraint.

15. The method of claim 11, further comprising:
in further response to the updating being determined to have been completed, modifying, by the first system, the graph based on alterations, resulting from the updating, to the dependencies between the respective ones of the configuration parameters.

16. The method of claim 11, wherein the dependency is a first dependency, and wherein the method further comprises:
updating, by the first system, a third computing component, of the computing components of the second system and different from the first computing component, at a same time as the updating of the first computing component, the updating of the third computing component comprising altering a third configuration parameter of the configuration parameters and associated with the third computing component; and
in response to the updating of the third computing component being determined to have been completed, modifying, by the first system, a fourth configuration parameter, of the configuration parameters and associated with a fourth computing component of the second system, based on the graph indicating a second dependency, of the dependencies, between the third configuration parameter and the fourth configuration parameter.

17. A non-transitory machine-readable medium comprising computer executable instructions that, when executed by at least one processor, facilitate performance of operations, the operations comprising:
generating a graph comprising nodes representative of configuration settings associated with components of a computing system, and edges representative of relationships between respective ones of the configuration settings, wherein the components of the computing system are of respective types selected from a group of types comprising an application component type, an operating system component type, and a hardware component type;
updating a first one of the components of the computing system, the updating comprising modifying a first configuration setting of the configuration settings and associated with the first one of the components; and
in response to the updating, modifying a second configuration setting, of the configuration settings and associated with a second one of the components of the computing system, based on the graph indicating a relationship, of the relationships, between the first configuration setting and the second configuration setting.

18. The non-transitory machine-readable medium of claim 17, wherein the graph is a first graph, wherein the nodes of the first graph are first nodes, wherein the edges of the first graph are first edges, wherein the relationships are first relationships, and wherein the operations further comprise:
generating a second graph comprising second nodes representative of the components of the computing system, and second edges representative of second relationships between respective ones of the components of the computing system, wherein the second nodes are arranged in respective layers of the second graph based on the second relationships.

19. The non-transitory machine-readable medium of claim 18, wherein the operations further comprise:
applying annotations to respective ones of the second nodes of the second graph, wherein the annotations are representative of respective configuration settings, of the configuration settings and associated with components of the computing system corresponding to the respective ones of the second nodes, and wherein the generating of the first graph comprises generating the first nodes of the first graph based on the annotations.

20. The non-transitory machine-readable medium of claim 17, wherein the operations further comprise:
in further response to the updating, modifying the graph based on alterations, resulting from the updating, to the relationships between the respective ones of the configuration settings.
